(19) United States
(12) Patent Application Publication
(10) Pub. No.: US 2024/0005758 A1
(43) Pub. Date: Jan. 4, 2024

(54) ELECTRONIC DEVICE, METHOD AND COMPUTER PROGRAM

(71) Applicant: Sony Semiconductor Solutions Corporation, Atsugi-shi, Kanagawa (JP)

(72) Inventors: Malte AHL, Stuttgart (DE); David DAL ZOT, Stuttgart (DE); Varun ARORA, Stuttgart (DE)

(73) Assignee: Sony Semiconductor Solutions Corporation, Atsugi-shi, Kanagawa (JP)

(21) Appl. No.: 18/037,775

(22) PCT Filed: Nov. 17, 2021
(86) PCT No.: PCT/EP2021/082024

§ 371 Date: May 19, 2023

(30) Foreign Application Priority Data
Nov. 26, 2020 (EP) 20210144.0

(51) Int. Cl. G08B 17/12; G06T 7/50; G06V 10/25; G06V 40/10

(52) U.S. Cl. CPC G08B 17/125; G06T 7/50; G06V 10/25; G06V 40/10; G06T 2207/10028

(57) ABSTRACT

An electronic device having circuitry configured to perform smoke detection based on a depth image and a confidence image captured by an iToF sensor to obtain a smoke detection status.

### TECHNICAL FIELD

The present disclosure generally pertains to the field of Time-of-Flight imaging, and in particular, to devices, methods and computer programs for Time-of-Flight image processing.

### TECHNICAL BACKGROUND

A Time-of-Flight (ToF) camera is a range imaging camera system that determines the distance of objects, included in a scene, by measuring the time of flight of a light signal between the camera and the object for each point of the image. A Time-of-Flight camera captures a depth image of the scene. Generally, a Time-of-Flight camera has an illumination unit that illuminates a region of interest with modulated light, and a pixel array that collects light reflected from the same region of interest. That is, a Time-of-Flight imaging system is used for depth sensing or providing a distance measurement.

In indirect Time-of-Flight (iToF), an iToF camera captures a depth image and a confidence image of the scene, wherein each pixel of the iToF camera is attributed with a respective depth measurement and confidence measurement. This operational principle iToF measurements is used in many applications related to image processing.

Although there exist techniques for image processing using Time-of-Flight cameras, it is generally desirable to provide better techniques for image processing using a Time-of-Flight camera.

### SUMMARY

According to a first aspect the disclosure provides an electronic device comprising circuitry configured to perform smoke detection based on a depth image and a confidence image captured by an iToF sensor to obtain a smoke detection status.

According to a second aspect the disclosure provides a method comprising performing smoke detection based on a depth image and a confidence image captured by an iToF sensor to obtain a smoke detection status.

According to a third aspect the disclosure provides a computer program comprising instructions which, when the program is executed by a computer, cause the computer to perform smoke detection based on a depth image and a confidence image captured by an iToF sensor to obtain a smoke detection status.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically shows the basic operational principle of a Time-of-Flight imaging system, which can be used for depth sensing or providing a distance measurement;

FIG. 2 schematically shows an embodiment of an iToF imaging system in an in-vehicle scenario, wherein images captured by the iToF imaging system are used for smoke detection inside the vehicle;

FIG. 3 schematically shows an embodiment of an in-vehicle imaging system comprising a ToF system used for smoke detection inside the vehicle;

FIG. 4 schematically shows an embodiment of a process of smoke detection based on a depth image and a confidence image;

FIG. 5a illustrates in more detail an embodiment of a number of ROI defined in the confidence image;

FIG. 5b illustrates in more detail an embodiment of a number of ROI defined in the depth image;

FIG. 6 schematically describes in more detail an embodiment of a process of smoke detection as described in FIG. 4;

FIG. 7a illustrates a confidence image generated by the iToF sensor capturing a scene in an in-vehicle scenario;

FIG. 7b illustrates a depth image generated by the iToF sensor capturing a scene in an in-vehicle scenario;

FIG. 8a schematically describes in more detail an embodiment of a process of smoke detection as described in FIG. 4;

FIG. 8b schematically describes in more detail an embodiment of a process of smoke detection as described in FIG. 4;

FIG. 9 shows a flow diagram visualizing a method for smoke detection status determination; and

FIG. 10 schematically describes an embodiment of an iToF device that can implement the processes of smoke detection and smoke detection status determination.

### DETAILED DESCRIPTION OF EMBODIMENTS

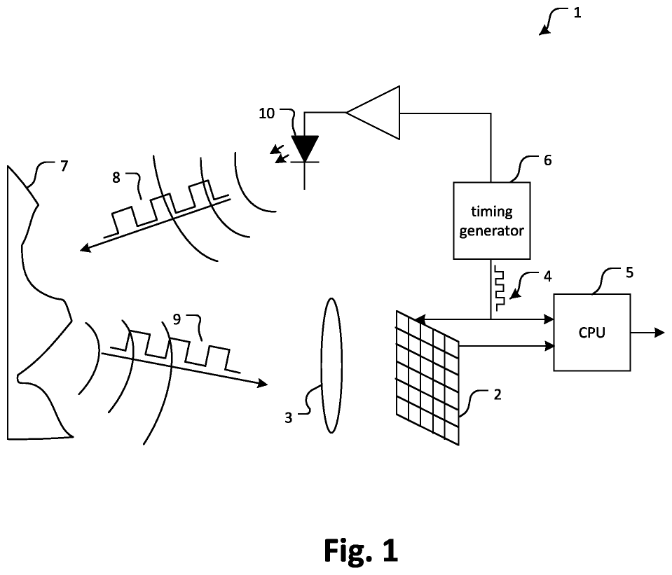

Before a detailed description of the embodiments under reference of FIG. 1 to FIG. 10, some general explanations are made.

The embodiments disclose an electronic device comprising circuitry configured to perform smoke detection based on a depth image and a confidence image captured by an iToF sensor to obtain a smoke detection status.

The circuitry of the electronic device may include a processor, may for example be CPU, a memory (RAM, ROM or the like), a memory and/or storage, interfaces, etc. Circuitry may comprise or may be connected with input means (mouse, keyboard, camera, etc.), output means (display (e.g. liquid crystal, (organic) light emitting diode, etc.)), a (wireless) interface, etc., as it is generally known for electronic devices (computers, smartphones, etc.). Moreover, circuitry may comprise or may be connected with sensors for sensing still images or video image data (image sensor, camera sensor, video sensor, etc.), for sensing environmental parameters (e.g. radar, humidity, light, temperature), etc.

The smoke detection may be performed in the cabin of a vehicle in an-in vehicle scenario, in a room monitoring scenario for security reasons, or the like. In an in-vehicle scenario, the iToF sensor may illuminate a reference area, such as for example, a dashboard of the cabin being within the iToF sensor's field-of-view. The dashboard may be used a reference are since it is usually made of black and non-reflective material, such that the risk of confusion with a detected object, being also present in the iToF sensor's field-of-view, is reduced, and thus, false positive results may be prevented.

In such a smoke detection process, an iToF system including the iToF sensor may detect interactions of driver and passenger within the reference area, interactions of driver or passenger very close to or in front of the TOF sensor, presence of large objects that could be placed on the dashboard, smoke blown by the driver and smoke blown by the passenger, smoke from E-cigarettes and normal tobacco based cigarettes, two or more hands that also interacts with the dashboard or behind, smoke without a cigarette being within the field-of-view of the iToF sensor, diffuse smoke, a clearly defined cloud of smoke, and the like.

The smoke detection status may be any smoke detection status, such as a status indicating that smoke is detected, a status indicating that smoke is not detected, a status indicating that smoke detection is not reliable, or the like. The smoke detection status may be output to a user to notify the user for smoke incidences. In an in-vehicle scenario, the smoke detection status may be output to a driver/passengers via an infotainment system, for example, by outputting a suitable sound from a loudspeaker array of the vehicle and/or by outputting text or an image on a display unit of the in-vehicle infotainment system. The smoke detection status may provide warning to the driver or may activate a safety related function whenever smoke would be detected in cabin.

The circuitry may be configured to define Regions of Interest, ROI, in each of the captured depth image and the captured confidence image, and to perform the smoke detection based on the ROIs defined in the depth image and in the confidence image. The number of the defined ROI may be any integer and positive number suitable to perform smoke detection, such as one, two, . . . , six, seven, . . . , or the like. The ROI may be defined in the captured images such as to be adjacent to one another for example when more than one ROI are defined, or the like.

The ROI defined in depth image and in the confidence image may be ROI having any size suitable for the smoke detection, such as for example 20×20 pixels, or the like.

Additionally, the ROI defined in depth image and in the confidence image may be ROI having any shape suitable for performing smoke detection and object recognition, such as circle, ellipse, polygon, line, polyline, rectangle, hand-drawn shape and the like.

According to some embodiments, the ROI in the depth image may be defined in the same positions as the ROI defined in the confidence image. Still further, the ROI in the depth image and in the confidence image may be defined in fixed positions. The positions of the ROI defined in the depth image and in the confidence image may be predefined position, or may be positions defined in real-time, or the like. The ROI may be defined in the captured images such as to form a group of ROI, in which the ROI are adjacent to each other, or one may be defined further away from the other(s), and the like.

According to some embodiments the circuitry may be configured to estimate a confidence value in the confidence image. The confidence value may be estimated based on an in-phase amplitude-modulated component, I, and based on a quadrature amplitude-modulated component, Q, wherein both of the I and Q component depends on the phase measurements related to respective distances calculated using the depth image.

Additionally, the confidence value may be estimated based on variation of light scattering or light reflection. Smoke may be detected based on the on variation of light scattering or light reflection, since smoke may cause an increase of brightness in the confidence image through the reflection of light. For example, in a case where a brightness value is almost equal everywhere in the confidence image, smoke incidence may have not occurred but an over saturation due to an object, such as a hand or paper being close to the iToF sensor. Typically, smoke does not appear in the depth image, therefore, when the presence of an object close to the iToF sensor may increase the confidence value in the confidence image but also the depth value in the depth image, and thus, a smoke detection status indicative of not smoke may be obtained.

Still further, a high number of very bright pixels in the confidence image, in a case where an object is detected, a smoke detection status may be obtained indicating that smoke is unlikely to be present, when the very bright pixels are outside the detected object.

The circuitry may be configured to calculate a respective confidence value in each of the ROI defined in the confidence image and to perform the smoke detection based on the calculated confidence values. For example, the circuitry may calculate for each respective pixel of the iToF sensor a confidence value and then may calculate a mean confidence value of all confidence values of the pixels within the respective ROI defined in the confidence image.

Still further, the circuitry may be configured to calculate a mean confidence value of all ROI based on the respective confidence values of the ROI. The mean confidence value of all ROI may be set as a confidence value threshold.

The circuitry may be configured to, when the confidence value threshold is reached by the respective confidence value of each ROI in at least the minimum number of ROI, obtain a smoke detection status which indicates that smoke is detected. Additionally, the circuitry may be configured to, when the confidence value threshold is not reached in at least the minimum number of ROI, obtain a smoke detection status which indicates that smoke is not detected. This may be estimated by comparing the respective confidence value of each ROI with the confidence value threshold.

The circuitry may be configured to detect the presence of an object based on object detection performed on the depth image. Object detection may be performed based on any object detection method known to the skilled person. The objects detected from the object detection method may be any object, such as a hand of a person, an arm of a person, a paper, a leg of a person, a pet and the like.

The circuitry may be configured to detect the presence of an object or a hand based on depth variation in the depth image. For example, the presence of an object typically increases the depth values, in the depth image, of the region in which the object is detected, such that a depth variation may be detected in the depth image.

According to an embodiment, the circuitry may be configured to filter out a ROI which is covered by a detected object to obtain a number of remaining ROI. The circuitry may be configured to filter out any ROI which is covered by a detected object, such that false positives and wrong smoke detection results are prevented.

The circuitry may be configured to filter out a ROI which has high depth variation in the depth image to obtain a number of remaining ROI. The circuitry may be configured to filter out any ROI that has high depth variation in the depth image, such that false positives and wrong smoke detection results are prevented.

The circuitry may be configured to, when the number of the remaining ROI is less than a predefined minimum number of ROI, obtain a smoke detection status which indicates that the smoke detection is not reliable. For example, when the smoke detection status indicates that the smoke detection is not reliable, the smoke detection process is paused or stopped. Alternatively, when the iToF sensor is covered for example, by an object, or when the dashboard area (ROI) is covered with objects, the smoke detection process is paused or stopped.

The circuitry may be configured to perform the smoke detection based on a variation of the respective confidence values in the ROI. The variation, in the confidence image, of the respective confidence values in the ROI, may be calculated using a standard deviation function, or the like.

According to the above described embodiments, smoke detection may be performed in low-light conditions, in night conditions, and the like. The depth measurement in the depth image may provide a desirable precision for classification, and the smoke detection based on the confidence values in the confidence image may be take advantage of light reflection in/on smoke. Thus, an iToF smoke detection can be considered as a light independent solution.

In smoke detection process, the combination of the depth image and the confidence image may be considered as a double security process for avoiding false positive results, by determining smoke presence based on confidence values, which are independent to any light conditions, and by using the depth measurements of the depth image to exclude objects that may cause modification of the confidence values in the confidence image.

The embodiments also disclose a method comprising performing smoke detection based on a depth image and a confidence image captured by an iToF sensor to obtain a smoke detection status.

The embodiments also disclose a computer program comprising instructions which, when the program is executed by a computer, cause the computer to perform smoke detection based on a depth image and a confidence image captured by an iToF sensor to obtain a smoke detection status. The computer program may implement any of the processes and/or operations that are described above or in the detailed description of the embodiments below.

Embodiments are now described by reference to the drawings.

Operational Principle of an Indirect Time-of-Flight Imaging System (iToF)

FIG. 1 schematically shows the basic operational principle of a Time-of-Flight imaging system, which can be used for depth sensing or providing a distance measurement, wherein the ToF imaging system 1 is configured as an iToF camera.

The ToF imaging system 1 captures three-dimensional (3D) images of a scene 7 by analysing the time of flight of infrared light emitted from an illumination unit 10 to the scene 7. The ToF imaging system 1 includes an iToF camera, for instance the imaging sensor 2 and a processor (CPU) 5. The scene 7 is actively illuminated with amplitude-modulated infrared light 8 at a predetermined wavelength using the illumination unit 10, for instance with some light pulses of at least one predetermined modulation frequency generated by a timing generator 6. The amplitude-modulated infrared light 8 is reflected from objects within the scene 7. A lens 3 collects the reflected light 9 and forms an image of the objects onto an imaging sensor 2, having a matrix of pixels, of the iToF camera. Depending on the distance of objects from the camera, a delay is experienced between the emission of the modulated light 8, e.g. the so-called light pulses, and the reception of the reflected light 9 at each pixel of the camera sensor. Distance between reflecting objects and the camera may be determined as function of the time delay observed and the speed of light constant value.

A three-dimensional (3D) images of a scene 7 captured by an iToF camera is also commonly referred to as “depth map”. In a depth map, each pixel of the iToF camera is attributed with a respective depth measurement.

In indirect Time-of-Flight (iToF), for each pixel, a phase delay between the modulated light 8 and the reflected light 9 is determined by sampling a correlation wave between the demodulation signal 4 generated by the timing generator 6 and the reflected light 9 that is captured by the imaging sensor 2. The phase delay is proportional to the object's distance modulo the wavelength of the modulation frequency. The depth map can thus be determined directly from the phase image, which is the collection of all phase delays determined in the pixels of the iToF camera.

In-Vehicle iToF Imaging System

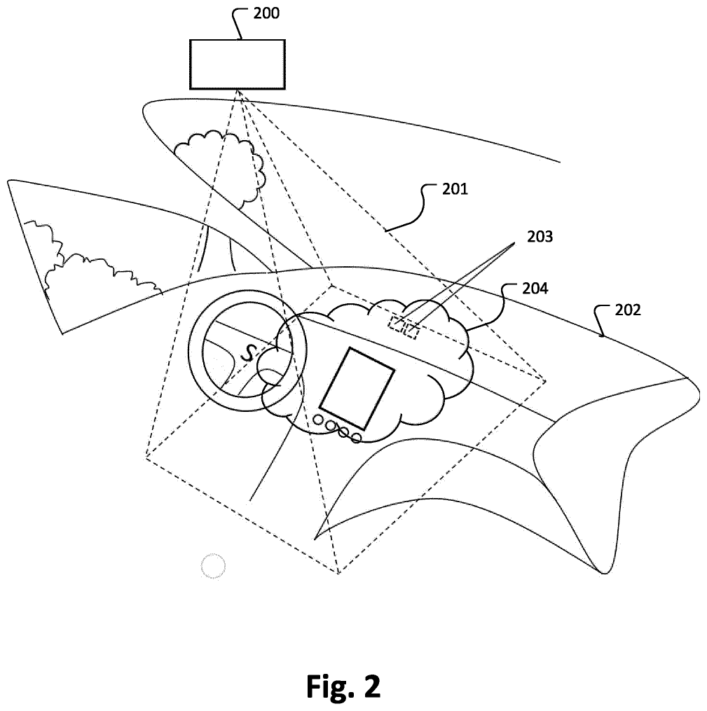

FIG. 2 schematically shows an embodiment of an iToF imaging system in an in-vehicle scenario. Images captured by the iToF imaging system are used for smoke detection inside the vehicle.

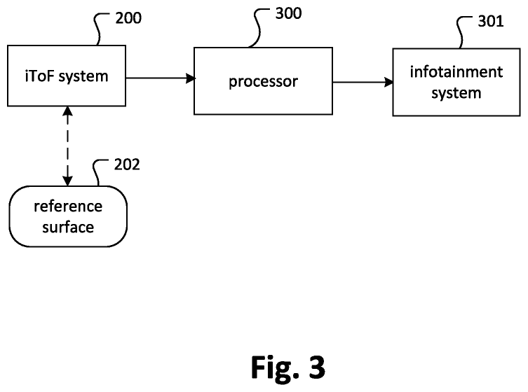

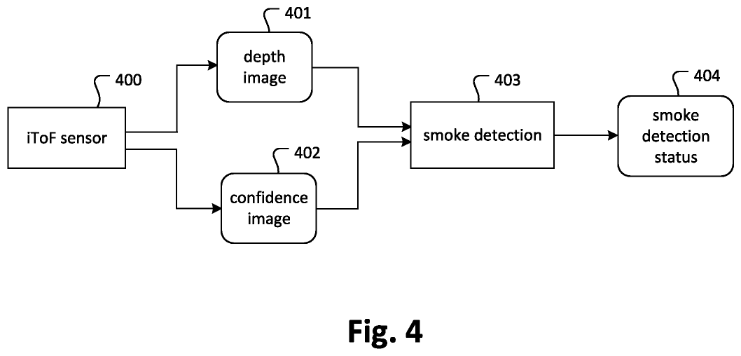

An iToF imaging system 200, e.g. an iToF camera, is fixed on the ceiling of a vehicle. The iToF imaging system 200 comprises an iToF sensor (see 400 in FIG. 4) that captures a predetermined area, field-of-view 201, inside the vehicle. For example, the iToF imaging system 200 captures, within its field-of-view 201, a dashboard 202 of the vehicle, which has an infotainment system, such as the infotainment system 301 shown in FIG. 3 below.

The iToF imaging system 200, which uses the operational principles of the ToF imaging system 1 described in FIG. 1 above, emits light pulses of infrared light to the predetermined area inside the vehicle by actively illuminating its field-of-view 201. The objects included in the field-of-view 201 of the iToF imaging system 200 reflect the emitted light back to the iToF imaging system 200. The iToF imaging system 200 captures a depth map (e.g. depth image) of the predetermined area inside the vehicle, by analysing the time of flight of the emitted infrared light. The objects included in the field-of-view 201 of the iToF sensor of the iToF imaging system 200 may be the dashboard 202 of the vehicle, a driver/passenger's hand, smoke 204, and the like.

The iToF imaging system 200 captures a depth image (i.e. depth map) and a confidence image of its field-of-view 201. Within the depth image and the confidence image there are defined pixel regions which correspond to predefined Regions Of Interest 203 in the field-of-view 201 of the iToF imaging system 200. Here, the predefined Regions Of Interest 203 are preferably located on the dashboard 202 of the vehicle. The dashboard 202 is made of a dark and non-reflective material and can thus be used as a reference surface (see 302 in FIG. 3) for the Regions Of Interest 203. Light emitted from the iToF imaging system 200 which hits the surface of the dark and non-reflective dashboard 202 does not reflect back to the iToF sensor, thus preventing wrong depth results.

A smoke detection process is performed based on the confidence image and the depth image provided by the iToF imaging system 200, in particular based on an analysis of the image regions which correspond to the predefined Regions Of Interest 203.

FIG. 3 schematically shows an embodiment of an in-vehicle imaging system comprising a ToF system used for smoke detection inside a vehicle.

An iToF system 200 generates a depth image (see 401 in FIG. 4) and a confidence image (see 402 in FIG. 4) of a reference surface 302 within its field-of-view (see 201 in FIG. 2). Based on the obtained depth image and the obtained confidence image, a processor 300 performs smoke detection (see 403 in FIG. 4) to obtain a smoke detection status (see 404 in FIG. 4), as described in more detail in FIGS. 4 to 8 below. Based on the smoke detection status the processor 300 controls an infotainment system 301 of the vehicle to notify the driver/passengers of the vehicle about the incidence of smoke inside the vehicle. In the in-vehicle infotainment system 301 a combination of functionality which delivers entertainment and information to the driver and the passengers is provided. In an in-vehicle infotainment system, entertainment and information is typically provided to the driver and the passengers through displays and loudspeakers. Control elements like button panels, touch screen displays, voice commands, and the like are provided to the driver and the passengers so that they can interact with the in-vehicle infotainment system 301. The infotainment system 301 may for example comprise an embedded multimedia/navigation system. The infotainment system 301 notifies the driver/passengers of smoke incidences, for example, by outputting a suitable sound from a loudspeaker array of the vehicle and/or by outputting text or an image on a display unit of the in-vehicle infotainment system 301. For example, the infotainment system 301 may notify the driver/user for smoke incidences by providing a warning or by activating a safety related function whenever smoke is detected in the cabin of the vehicle. In this way, a driver may for example be encouraged to stop smoking in a case where smoke is detected when a child is present in the vehicle (as detected e.g. by pressure sensors in the backseats).

In an in-vehicle scenario, the smoke detection process may detect smoke produced by the driver and/or smoke produced by a passenger. The smoke detection process may detect a clearly defined cloud of smoke, diffuse smoke, smoke produced by cigarettes, smoke coming from the engine of the vehicle, and the like. In particular, the smoke detection process of the embodiments may detect that a passenger is smoking without the need of detecting a cigarette in the field-of-view of the iToF sensor.

In the embodiment of FIG. 3, the smoke detection is performed in an in-vehicle scenario.

Alternatively, in a room security scenario, smoke detection may also be performed in a room. In a case where smoke detection is performed in a room, the iToF sensor may for example be mounted on the ceiling of the room, or at any suitable location. Regions of Interest may be defined on any suitable reference surfaces within the room, such as walls, tables, etc.

FIG. 4 schematically shows an embodiment of a process of smoke detection based on a depth image and a confidence image.

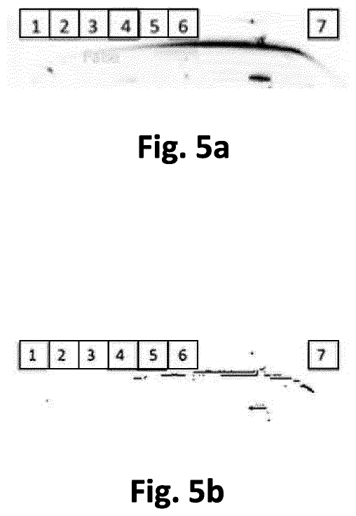

An iToF sensor 400 captures a predetermined area within its field-of-view, using iToF technology, to obtain a depth image 401 and a confidence image 402 of the field-of-view (see 202 in FIG. 2). Based on the depth image 401 and the confidence image 402 of the captured area, smoke detection 403 is performed to obtain a smoke detection status 404. An embodiment of the process of smoke detection 403 is described in more detail with regard to FIG. 5 below. The process of smoke detection may be for example be performed in an in-vehicle scenario, in a room monitoring scenario, or the like.

The depth image 401 is an image or an image that contains information relating to the distance of objects in a scene (see 7 in FIG. 1) from the optical center of the camera (e.g. from the iToF sensor 400). The depth image 401 can for example be determined directly from a phase image, which is the collection of all phase delays determined in the pixels of the iToF sensor 400. The confidence image 402 is an image that contains a confidence measure related to the depth information.

Regions of Interest (ROI)

According to the embodiments described below in more detail, to perform a smoke detection process, the iToF sensor confidence image (see 402 in FIG. 4) and the iToF sensor depth image (see 401 in FIG. 4) are analyzed. A predetermined number of Regions of Interest (ROD (see 203 in FIG. 2) are defined in the depth image 401 and in the confidence image 402. These Regions of Interest (ROI) correspond to reference surfaces within the field-of-view (see 201 in FIG. 2) of the iToF sensor.

In an in-vehicle scenario, an iToF sensor, which is mounted for example on the ceiling of the cabin of the vehicle, captures a scene (e.g. a predetermined area) within its field-of-view (see 201 in FIG. 2) to generate a depth image (see 401 in FIG. 4) and a confidence image (see 402 in FIG. 4) of the captured scene. The captured scene is for example a dashboard (see 202 in FIG. 2) of the vehicle. Therefore, since the dashboard of the vehicle is typically a dark and non-reflective material, the predetermined number of ROI 203, i.e. n ROI 203, are defined within the region of the dashboard, in each confidence image and depth image. For improving the smoke detection results and preventing false positive smoke detection results, during the smoke detection process 403, the n number of ROI have fixed positions in the confidence image 402 (see FIG. 5a) and in the depth image 401 (see FIG. 5b). Additionally, the position of the n ROI 203, on the dashboard (see 202 in FIG. 2), defined in the confidence image 402 (see FIG. 5a) are the same with the positions of the n ROI 203 defined in the depth image 401 (see FIG. 5b).

FIGS. 5a and 5b schematically illustrate an embodiment of a predetermined number of ROI defined in each confidence image and depth image.

FIG. 5a illustrates in more detail an embodiment of a number of ROI defined in the confidence image. In the confidence image, the dashboard is depicted, wherein a small part of the dashboard appears as black color in the confidence image, while the rest of the dashboard appears as light gray color or white color in the confidence image. Here, black color refers to a high confidence value and light gray color or white color refers to a low confidence value. The black color indicates that these parts are located closer to the iToF sensor. The indication “False” in the confidence image is the final output of the smoke detector after its entire evaluation is completed, so in this embodiment, no smoke is detected.

In the embodiment of FIG. 5a, a predetermined number n of ROI 203 are defined in the confidence image generated by the iToF sensor (see 400 in FIG. 4). The ROI 203 are represented by rectangular boxes, wherein each rectangular box is indicative of a respective region of interest. The number n of ROI 203-n is an integer number, which may preferably be n>1, here, the number n of ROI is equal to 7, i.e. n=7, as shown the number inside each rectangular box, which represents a respective ROI 203. The first six ROI 203-1 to 203-6, forming a group of ROI, are adjacent to each other and are defined within the region of the dashboard 202 of the vehicle. The seventh ROI 203-7, which is also within the region of the dashboard 202 depicted in the confidence image, is defined further away from the first six ROI 203-1 to 203-6.

For example, when a hand, or head of the driver or an object comes very close to the iToF sensor causes a strong reflection together with a scattering of light effect. This results to an increase of brightness in the entire confidence image that is relatively uniform. This arrangement of the ROI 203-n at different positions in the confidence image (ROI 203-1 to 203-6, forming a group of ROI, and ROI 203-7 further away) make is possible to distinguish between an uniform increase of brightness, for example, from a hand that is very close to the iToF sensor and an increase of brightness that has variation and is caused by a light reflection from smoke.

FIG. 5b illustrates in more detail an embodiment of a number of ROI defined in the depth image. In the depth image, the dashboard is depicted as in the confidence image with regard to FIG. 5a above. Here, the part of the dashboard that appears as black color in the depth image indicates that this part is located closer to the iToF sensor. The number of ROI 203 defined in the depth image 401 is the same with the number of ROI 203 defined in the confidence image 402, as described in FIG. 5a above. That is, the number n of ROI 203 defined in the depth image 401 is n=7, as shown the number inside each rectangular box, which represents a respective ROI 203. In addition, the ROI 203 defined in the confidence image are the same with the ROI 203 defined in the depth image and in both images, the ROI 203 have the same fixed positions.

In the embodiments of FIGS. 5a and 5b the number n of ROI 203 is equal to seven, i.e. n=7, without limiting the present embodiment in that regard. Alternatively, the number n of ROI 203 defined in the depth image and the confidence image may be any suitable number for the case.

In the embodiments of FIGS. 5a and 5b, the shape of the ROI 203 is rectangular, without limiting the present invention in that regard. The shape of the ROI 203 may be any suitable shape including circles, ellipses, polygons, lines, polylines, rectangles, hand-drawn shapes and the like. The size of the ROI 203 may be any size suitable for the desirable detection and computations. For example, the size of each ROI 203 may be 20×20 pixels, which may relate to approximately a length of 1-2 cm on the dashboard. The resolution of the iToF sensor may be any suitable resolution, such that Video Graphics Array (VGA) resolution may be applied, a higher resolution than VGA resolution or a low resolution may be applied. For example, the resolution to be applied may be up to 1.8 Mpixel, without limiting the present embodiment in that regard.

Each ROI may for example be defined as a rectangular box having size bigger than a pixel size to avoid introducing noise to the values.

Smoke Detection Method

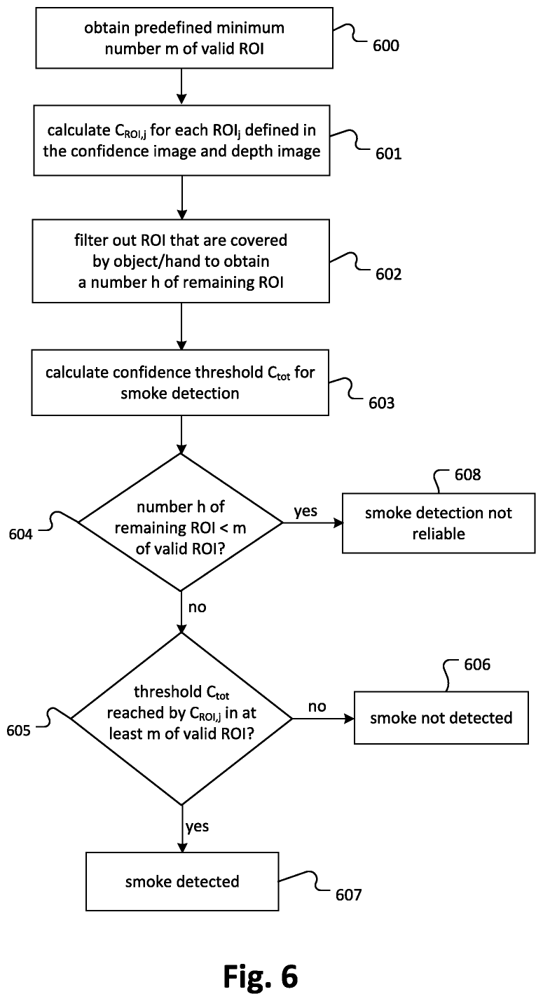

FIG. 6 schematically describes in more detail an embodiment of a process of smoke detection as described in FIG. 4 above.

In this embodiment, an iToF sensor (see 400 in FIG. 4) illuminates an in-vehicle scene, within its field-of-view (see 201 in FIG. 2) and captures a depth image (see 401 in FIG. 4) and a confidence image (see 402 in FIG. 4) of the field-of-view. A predefined number n of Regions of Interest (ROI) are defined in each one of the confidence image and the depth image. The n ROI may for example be adjacent to one another and the n ROI of the confidence image may be defined in the same and fixed positions in the depth image (see FIG. 5a, b).

At 600, a predefined minimum number m is obtained. This minimum number m describes the minimum number of valid ROI that are considered as necessary for a meaningful smoke detection. This minimum number m may for example be set in advance (at time of manufacture, system setup, etc.) as a predefined parameter of the process. At 601, a confidence value C_{ROI,j} is calculated for each ROI j of the n ROI defined in the confidence image and the depth image. At 602, object detection is performed in the depth image in order to detect an object such as a hand within the field-of-view of the iToF camera and the ROI that either are covered by an object/hand are filtered out to obtain a number h of valid ROI. The ROI that are filtered out are considered as invalid and are not further considered for smoke detection. At 603, a confidence threshold Cₜₒₜ is calculated for smoke detection based on the respective confidence values C_{ROI,j} of the valid ROI defined in the confidence image. At 604, if the number h of valid ROI is more than m, the method proceeds at 605. If the number h of valid ROI is less than m, the method proceeds at 608 and at 608 a smoke detection status is determined which indicates that the smoke detection is not reliable. At 605, it is checked if in at least m ROI the respective confidence value C_{ROI,j} calculated at 601 has reached the confidence threshold Cₜₒₜ calculated at 603. If the result at 605 is yes, then the method proceeds at 607. At 607, a smoke detection status is determined that indicates that smoke is detected. If the result at 605 is no, then the method proceeds at 606. At 606, a smoke detection status is determined that indicates that smoke is not detected.

According to an embodiment, confidence of a pixel is calculated based on an in-phase amplitude-modulated component and a quadrature amplitude-modulated component of the pixel, and it is given by:

C=|I|+|Q|

where I is an in-phase amplitude-modulated component, when simplified I is defined as I=cos φ and Q is a quadrature amplitude-modulated component, when simplified Q is defined as Q=sin φ, where φ is a phase measurement value corresponding to a respective distance. The confidence image contains the confidence values Cᵢ of each pixel within the captured image.

At 601, the mean confidence value in each ROI j, C_{ROI,j}, may for example be computed as:

$${C}_{ROI , j} = \frac{1}{{X}_{j}} {\sum }_{i ∈ ROI J} {C}_{i}$$

where Xⱼ is the number of pixels i within ROI j:

$${X}_{j} = {\sum }_{i ∈ ROI J} 1$$

The mean confidence value of all n ROI, Cₜₒₜ, within the confidence image may be determined at 603 as:

$${C}_{tot} = \frac{1}{N} {\sum }_{j = 1}^{N} {C}_{ROI , j}$$

where N is the number of ROI (here N=7) and C_{ROI,j} is the (mean) confidence value of ROI j.

The confidence variation in the set of ROI may be computed by the standard deviation function as:

$$s = \sqrt{\frac{1}{Z - 1} {\sum }_{j = 1}^{Z} {( {C}_{ROI , j} - {C}_{tot} )}^{2}}$$

where Z is the number of the defined ROI, Cₜₒₜ is the mean confidence value of all ROI within the confidence image and C_{ROI,j} is the (mean) confidence value of ROI j within the confidence image.

In the embodiment of FIG. 6, at 602 object detection is performed in the depth image in order to detect an object such as a hand within the field-of-view of the iToF camera and the ROI that either are covered by an object/hand are filtered out. In alternative embodiments, alternatively or in addition, a depth variation in each of the n ROI is determined, and those ROI with too high depth variation are disregarded.

In the embodiment of FIG. 6, object detection, such as hand detection is performed, or it is performed determination of a depth variation in each of the n ROI. Based on the depth variation in each of the n ROI, it is detected whether there is an object/hand in the captured images. In a case where there is an object/hand detected, the respective ROI are not further considered for smoke detection (filtered out). This allows to prevent that an object, or a hand induces a variation of light scattering or light reflection in each of the n ROI, giving a false positive result for smoke detection.

Object Detection and ROI Filtering

An embodiment of object detection as performed at process 602 of FIG. 6 is now described in more detail. The object detection may be performed based on any object detection method known to the skilled person. An exemplary object detection method is described by Shuran Song and Jianxiong Xiao in the published paper “Sliding Shapes for 3D Object Detection in Depth Images” Proceedings of the 13th European Conference on Computer Vision (ECCV2014).

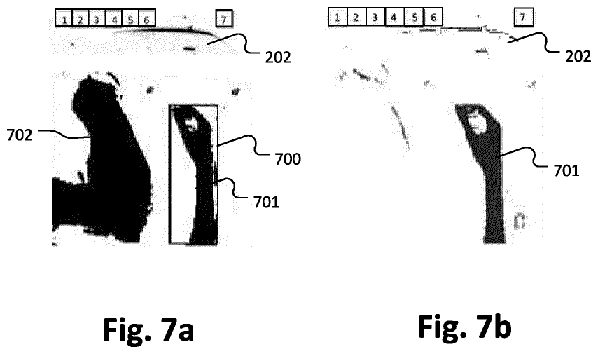

FIG. 7a illustrates a confidence image generated by the iToF sensor capturing a scene in an in-vehicle scenario and FIG. 7b illustrates a corresponding depth image. The scene comprises the dashboard 202 of the vehicle, the right hand 701 of the vehicle's driver and the right leg 702 of the driver. An object/hand recognition method is performed, preferably, on the depth image (see FIG. 7b). In a case where an object is detected, such as a hand, an active bounding box 700 relating to the detected hand in the confidence image 402 (see FIG. 7a) is provided by the object detection process. A predetermined number n of ROI 203-n, here n=7, are defined in the confidence image. In FIG. 7a, each ROI is represented by a rectangular box 203-1 to 203-7 so that seven rectangular boxes are shown in FIG. 7a. Six ROI 203-1 to 203-6 are adjacent to each other forming a group of ROI and the seventh ROI 203-7 is defined further away in the confidence image.

If the active bounding box, which includes the detected hand, overlaps one or more of the n ROI 203, these overlapped ROI 203 are not considered for smoke detection. They are filtered out as described at 602 in FIG. 6. In the case where an object/hand is detected and the bounding box 700 covers at least one of the defined ROI 203, the covered ROI 203 is not further considered for smoke detection or the smoke detection process 403 is paused or stopped. The ROI 203 in the depth image are used to observe occlusions occurred by a detected object/hand, such that false positives are avoided.

Alternatively, the smoke detection method is paused, since it is considered as not reliable, when the active bounding box 700 covers at least one of the n ROI, or when the active bounding box covers all of the n−h ROI, wherein h (remaining ROI after filtering) being an integer and 1<h<n, or when active bounding box covers all of the n ROI.

As described above, the each one of the ROI 203 in the depth image has exactly the same coordinates as in the confidence image. Smoke does not appear in the depth image because it is considered as noise and it is filtered out. An object, such as a hand, a finger, and the like, would appear in both images. This makes it possible to avoid a false positive from a detected finger, hand (here appears as black color) in the confidence image.

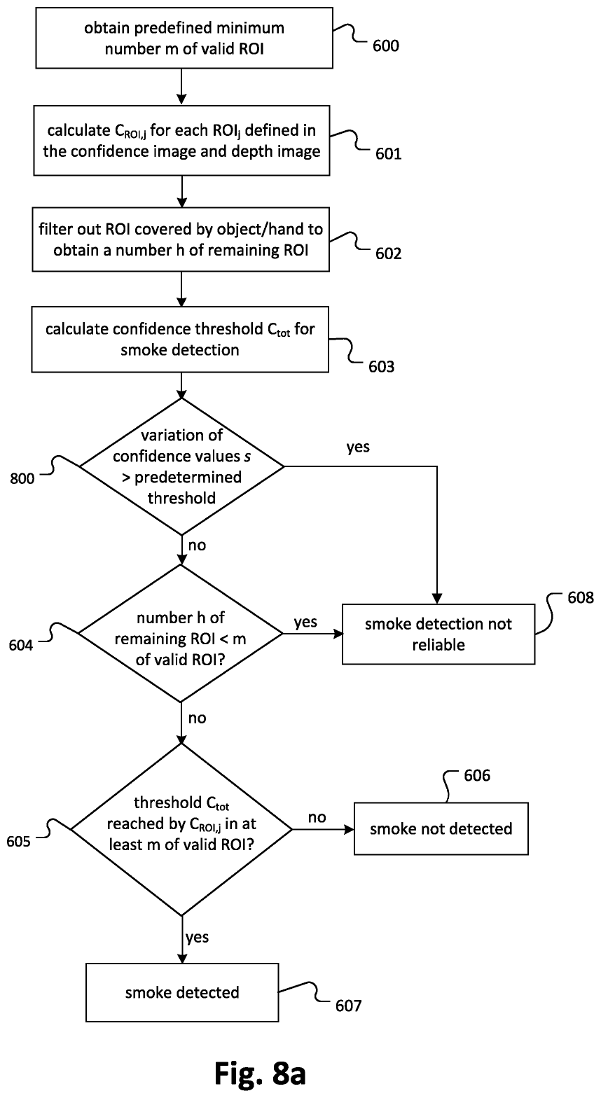

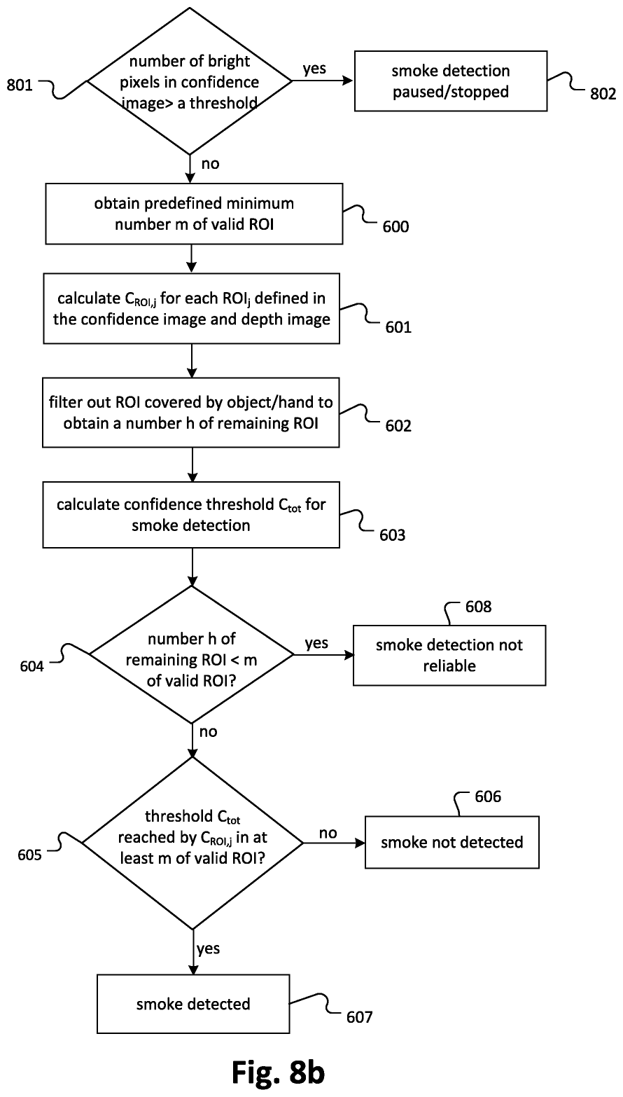

FIG. 8a schematically describes in more detail an embodiment of a process of smoke detection as described in FIG. 4. In this implementation, a variation of the confidence values in the set of ROI using standard deviation function s is computed.

The embodiment of FIG. 8a is similar with the embodiment of FIG. 6 above, wherein additionally to the steps of FIG. 6, the confidence variation s in the set of defined ROI is computed to determine a smoke detection status.

A predefined minimum number m of valid ROI necessary for a meaningful smoke detection is obtained, at 600. A confidence value C_{ROI,j} for each ROI j of the n ROI and a confidence threshold Cₜₒₜ is calculated, at 601, and at 603, for smoke detection based on the respective confidence values C_{ROI,j} of the valid ROI. The ROI covered by a detected object are filtered out, such that a number h of the remaining ROI is obtained, at 602. If the confidence variation s is more than a predetermined threshold, at 800, the method proceeds at 608 and at 608 a smoke detection status is determined which indicates that the smoke detection is not reliable. If the confidence variation s is less than a predetermined threshold, at 800, the method proceeds at 604 and at 604, if the number h of valid ROI is more than m, the method proceeds at 605. If the number h of valid ROI is less than m, the method proceeds at 608 and at 608 a smoke detection status is determined which indicates that the smoke detection is not reliable. At 605, it is checked if in at least m ROI the respective confidence value C_{ROI,j} has reached the confidence threshold Cₜₒₜ. If the result at 605 is yes, then the method proceeds at 607. At 607, a smoke detection status is determined that indicates that smoke is detected. If the result at 605 is no, then the method proceeds at 606. At 606, a smoke detection status is determined that indicates that smoke is not detected.

The confidence variation s in the set of defined ROI is computed based on the calculated confidence value C_{ROI,j} for each ROI j of the n ROI and based on the confidence threshold Cₜₒₜ.

The confidence variation s in the set of ROI may be computed by the standard deviation function as:

$$s = \sqrt{\frac{1}{Z - 1} {\sum }_{j = 1}^{Z} {( {C}_{ROI , j} - {C}_{tot} )}^{2}}$$

where Z is the number of the defined ROI, Cₜₒₜ is the mean confidence value of all ROI within the confidence image and C_{ROI,j} is the (mean) confidence value of ROI j within the confidence image.

During the smoke detection described above, a smoke detection status is determined based on the depth variation in the n ROI and based on the (mean) confidence in all of the n ROI within one image (without relying on the depth image) to measure variation s of light reflection, using the standard deviation function s described above. That is, the variation s of mean confidence values Cₜₒₜ is compared with a threshold for smoke detection. This threshold may be any suitable threshold for smoke detection.

FIG. 8b schematically describes in more detail an embodiment of a process of smoke detection as described in FIG. 4. The embodiment of FIG. 8b is similar with the embodiment of FIG. 6 above, wherein additionally to the steps of FIG. 6, umber of bright pixels in the confidence image is computed to determine a smoke detection status. In this implementation, before the steps performed with regard to FIG. 6 above, if a number of bright pixels computed in the confidence image is more than a threshold, at 801, the method proceeds at 802. At 802, the smoke detection process is paused or stopped, since it is considered unlikely the presence of smoke. If a number of bright pixels computed in the confidence image is less than a threshold, at 801, the method proceeds at 600. At 600 the method proceeds as described in the embodiment of FIG. 6.

In the embodiment of FIG. 8b, when their number of calculated bright pixels is above a predetermined threshold for bright pixel, the determination of presence of smoke is paused or stopped because either it is considered unlikely the presence of smoke or because smoke detection is not reliable (see 608 in FIG. 6). In a case where the number of bright pixels is above said threshold, there is a risk of false positive because of light scattering of a detected object coming to close to the iToF sensor. That is because, typically, when an object comes close to the iToF sensor, light scattering in the ROI is detected.

Calibration

The iToF system 200 described in the embodiments above, is calibrated for example, by capturing an image and performing background subtraction in the captured image. The rectangular shaped ROI 203 may be defined in each of the confidence image and in the depth image based on the subtracted background. Calibration may be performed using any other calibration method known to the skilled person.

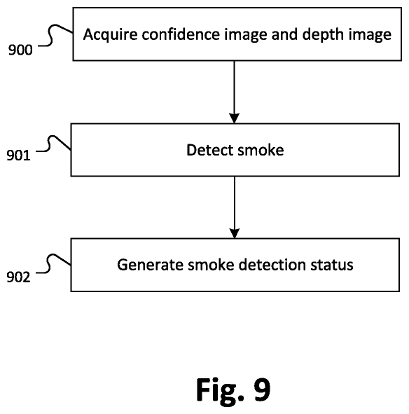

FIG. 9 shows a flow diagram visualizing a method for smoke detection status determination. At 900, a depth image (see 401 in FIG. 4) and a confidence image (see 402 in FIG. 4) are acquired by an iToF sensor (see 400 in FIG. 4) that captures a scene (see 202 in FIG. 2) within its field-of-view (see 201 in FIG. 2), for example, in an in-vehicle scenario. At 901, smoke detection (see 403 in FIG. 4) is performed, as described in FIG. 4 and FIG. 6 above. At 902, a smoke detection status (see 404 in FIG. 4) is generated, based on the smoke detection result obtained at 901. The smoke detection status may be e.g. smoke detection not reliable, e.g. smoke not detected, or e.g. smoke detected, as described in FIG. 5 above.

Implementation

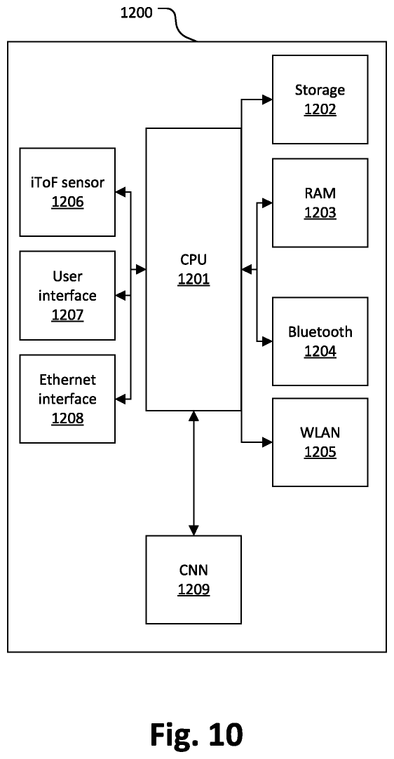

FIG. 10 schematically describes an embodiment of an iToF device that can implement the processes of smoke detection and smoke detection status determination, as described above. The electronic device 1200 comprises a CPU 1201 as processor. The electronic device 1200 further comprises an iToF sensor 1206, and a convolutional neural network unit 1209 that are connected to the processor 1201. The processor 1201 may for example implement the smoke detection 403 that realize the processes described with regard to FIG. 3 and FIG. 4 in more detail. The CNN 1209 may for example be an artificial neural network in hardware, e.g. a neural network on GPUs or any other hardware specialized for the purpose of implementing an artificial neural network. The CNN 1209 may thus be an algorithmic accelerator that makes it possible to use the technique in real-time, e.g., a neural network accelerator. The electronic device 1200 further comprises a user interface 1207 that is connected to the processor 1201. This user interface 1207 acts as a man-machine interface and enables a dialogue between an administrator and the electronic system. For example, an administrator may make configurations to the system using this user interface 1207. The electronic device 1200 further comprises a Bluetooth interface 1204, a WLAN interface 1205, and an Ethernet interface 1208. These units 1204, 1205 act as I/O interfaces for data communication with external devices. For example, video cameras with Ethernet, WLAN or Bluetooth connection may be coupled to the processor 1201 via these interfaces 1204, 1205, and 1208. The electronic device 1200 further comprises a data storage 1202 and a data memory 1203 (here a RAM). The data storage 1202 is arranged as a long-term storage, e.g. for storing the algorithm parameters for one or more use-cases, for recording iToF sensor data obtained from the iToF sensor 1206 and provided to from the CNN 1209, and the like. The data memory 1203 is arranged to temporarily store or cache data or computer instructions for processing by the processor 1201.

It should be noted that the description above is only an example configuration. Alternative configurations may be implemented with additional or other sensors, storage devices, interfaces, or the like.

It should be recognized that the embodiments describe methods with an exemplary ordering of method steps. The specific ordering of method steps is, however, given for illustrative purposes only and should not be construed as binding. For example, the step 601 in FIG. 6 can be performed after the step 603, or the like.

It should also be noted that the division of the electronic device of FIG. 10 into units is only made for illustration purposes and that the present disclosure is not limited to any specific division of functions in specific units. For instance, at least parts of the circuitry could be implemented by a respectively programmed processor, field programmable gate array (FPGA), dedicated circuits, and the like.

All units and entities described in this specification and claimed in the appended claims can, if not stated otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An electronic device comprising circuitry configured to perform smoke detection (403) based on a depth image (401) and a confidence image (402) captured by an iToF sensor (400) to obtain a smoke detection status (404, 606, 607, 608).

(2) The electronic device of (1), wherein the circuitry is configured to define Regions of Interest, ROI, (203) in each of the captured depth image (401) and the captured confidence image (402), and to perform the smoke detection (403) based on the ROIs defined in the depth image (401) and in the confidence image (402).

(3) The electronic device of (1) or (2), wherein the ROI (203) in the depth image (401) are defined in the same positions as the ROI (203) defined in the confidence image (402).

(4) The electronic device of (2) or (3), wherein the ROI (203) in the depth image (401) and in the confidence image (402) are defined in fixed positions.

(5) The electronic device of anyone of (1) to (4), wherein the circuitry is configured to estimate a confidence value (C, C_{ROI,j}, Cₜₒₜ) in the confidence image (402).

(6) The electronic device of (2), wherein the circuitry is configured to calculate a respective confidence value (C_{ROI,j}) in each of the ROI (203) defined in the confidence image (402) and to perform the smoke detection (403) based on the calculated confidence values (C_{ROI,j}).

(7) The electronic device of (6), wherein the circuitry is configured to calculate a mean confidence value (Cₜₒₜ) of all ROI (203) based on the respective confidence values (C_{ROI,j}) of the ROI (203).

(8) The electronic device of (7), wherein a confidence value threshold (Cₜₒₜ) is set as the mean confidence value of all ROI (203) (Cₜₒₜ).

(9) The electronic device of (7), wherein the circuitry is configured to, when the confidence value threshold (Cₜₒₜ) is reached by the respective confidence value (C_{ROI,j}) of each ROI (203) in at least the minimum number (m) of ROI (203), obtain a smoke detection status (607) which indicates that smoke is detected.

(10) The electronic device of (7), wherein the circuitry is configured to, when the confidence value threshold (Cₜₒₜ) is not reached in at least the minimum number (m) of ROI (203), obtain a smoke detection status (606) which indicates that smoke is not detected.

(11) The electronic device of (2), wherein the circuitry is configured to detect the presence of an object based on object detection performed on the depth image (401).

(12) The electronic device of (11), wherein the object is a hand.

(13) The electronic device of (2), wherein the circuitry is configured to detect the presence of an object or a hand based on depth variation in the depth image (401).

(14) The electronic device of (11), wherein the circuitry is configured to filter out a ROI (203) which is covered by a detected object to obtain a number (h) of remaining ROI.

(15) The electronic device of (2), wherein the circuitry is configured to filter out a ROI (203) which has high depth variation in the depth image (401) to obtain a number (h) of remaining ROI.

(16) The electronic device of (12), wherein the circuitry is configured to, when the number h of the remaining ROI (203) is less than a predefined minimum number (m) of ROI (203), obtain a smoke detection status (608) which indicates that the smoke detection is not reliable.

(17) The electronic device of (6), wherein the circuitry is configured to perform the smoke detection (403) based on a variation (s) of the respective confidence values (C_{ROI,j}) in the ROI (203).

(18) A method comprising performing (901) smoke detection (403) based on a depth image (401) and a confidence image (402) captured by an iToF sensor (400) to obtain a smoke detection status (404).

(19) A computer program comprising instructions which, when the program is executed by a computer, cause the computer to carry out the method of (18).

(20) A non-transitory computer-readable recording medium that stores therein a computer program product, which, when executed by a computer, cause the computer to carry out the method of (18).

1. An electronic device comprising circuitry configured to perform smoke detection based on a depth image and a confidence image captured by an iToF sensor to obtain a smoke detection status.

2. The electronic device of claim 1, wherein the circuitry is configured to define Regions of Interest, ROI, in each of the captured depth image and the captured confidence image, and to perform the smoke detection based on the ROIs defined in the depth image and in the confidence image.

3. The electronic device of claim 2, wherein the ROI in the depth image are defined in the same positions as the ROI defined in the confidence image.

4. The electronic device of claim 2, wherein the ROI in the depth image and in the confidence image are defined in fixed positions.

5. The electronic device of claim 1, wherein the circuitry is configured to estimate a confidence value in the confidence image.

6. The electronic device of claim 2, wherein the circuitry is configured to calculate a respective confidence value in each of the ROI defined in the confidence image and to perform the smoke detection based on the calculated confidence values.

7. The electronic device of claim 6, wherein the circuitry is configured to calculate a mean confidence value of all ROI based on the respective confidence values of the ROI.

8. The electronic device of claim 7, wherein a confidence value threshold is set as the mean confidence value of all ROI.

9. The electronic device of claim 7, wherein the circuitry is configured to, when the confidence value threshold is reached by the respective confidence value of each ROI in at least the minimum number of ROI, obtain a smoke detection status which indicates that smoke is detected.

10. The electronic device of claim 7, wherein the circuitry is configured to, when the confidence value threshold is not reached in at least the minimum number of ROI, obtain a smoke detection status which indicates that smoke is not detected.

11. The electronic device of claim 2, wherein the circuitry is configured to detect the presence of an object based on object detection performed on the depth image.

12. The electronic device of claim 11, wherein the object is a hand.

13. The electronic device of claim 2, wherein the circuitry is configured to detect the presence of an object or a hand based on depth variation in the depth image.

14. The electronic device of claim 11, wherein the circuitry is configured to filter out a ROI which is covered by a detected object to obtain a number of remaining ROI.

15. The electronic device of claim 2, wherein the circuitry is configured to filter out a ROI which has high depth variation in the depth image to obtain a number of remaining ROI.

16. The electronic device of claim 12, wherein the circuitry is configured to, when the number of the remaining ROI is less than a predefined minimum number of ROI, obtain a smoke detection status which indicates that the smoke detection is not reliable.

17. The electronic device of claim 6, wherein the circuitry is configured to perform the smoke detection based on a variation of the respective confidence values in the ROI.

18. A method comprising performing smoke detection based on a depth image and a confidence image captured by an iToF sensor to obtain, by circuitry, a smoke detection status.

19. A non-transitory storage medium comprising code components which, when executed by a computer, cause the computer to perform the method of claim 18.
